(19) United States
(12) Patent Application Publication
(10) Pub. No.: US 2020/0010017 A1
(43) Pub. Date: Jan. 9, 2020

(54) WIDE AREA SURROUND VIEW MONITORING APPARATUS FOR VEHICLE AND CONTROL METHOD THEREOF

(71) Applicant: Hyundai Mobis Co., Ltd., Seoul (KR)

(72) Inventor: Heung Rae CHO, Yongin-si (KR)

(21) Appl. No.: 16/506,065

(22) Filed: Jul. 9, 2019

(30) Foreign Application Priority Data
Jul. 9, 2018 (KR) 10-2018-0079384

(51) Int. Cl. B60R 1/00; G06K 9/00; G06T 7/70

(52) U.S. Cl. CPC B60R 1/00; G06K 9/00805; G06K 9/00798; G06T 2207/30256; B60R 2300/303; B60R 2300/50; G06T 2207/30261; G06T 7/70

(57) ABSTRACT

A wide area surround view monitoring apparatus for a vehicle includes: a camera module installed in an ego (self-driving) vehicle, and configured to acquire a surround image, wirelessly transmit the acquired surround image, wirelessly receive a camera image from a neighboring vehicle to measure RSSI, and transmit the RSSI with the surround image of the ego vehicle and the camera image of the neighboring vehicle through a vehicle network; and a controller configured to receive the surround image of the ego vehicle, the camera image of the neighboring vehicle and the RSSI from the camera module, determine and output a possibility of collision with the neighboring vehicle, configure a wide area SVM view by synthesizing the surround image of the ego vehicle with the camera image of the neighboring vehicle, and generate a local wide area image map by calculating a possible driving space of the ego vehicle.

### CROSS-REFERENCES TO RELATED APPLICATION

The present application claims priority from and the benefit of Korean Patent Application No. 10-2018-0079384, filed on Jul. 9, 2018, which is hereby incorporated by reference for all purposes as if fully set forth herein.

### BACKGROUND

### Field

Exemplary embodiments relate to a wide area surround view monitoring apparatus for a vehicle and a control method thereof, and more particularly, to a wide area surround view monitoring apparatus for a vehicle, which receives a camera image from a neighboring vehicle, generates a wide area surround view by synthesizing the camera image of the neighboring vehicle with a surround image of an ego vehicle, provides a collision prevention function through a degree of overlap between the images, and generates a local wide area image map around the ego vehicle, and a control method thereof.

### Discussion of the Background

With the development of the automobile industry, vehicles have been widely spread. In order to not only improve the stability of vehicles but also promote driver convenience, various high-tech electronic technologies have been applied to vehicles.

Such high-tech electronic technologies may include a surround view monitoring system for a vehicle, which captures an image of the surrounding environment of a vehicle, and displays a top view or around view image for a driver to conveniently check the surrounding environment of the vehicle with the naked eye.

The surround view monitoring system for a vehicle captures an image of the surrounding environment through cameras installed at the front, rear, left and right of the vehicle, corrects an overlap area based on the captured image such that the overlap area looks natural, and displays the surrounding environment of the vehicle on the screen. Therefore, the driver can accurately recognize the surrounding environment of the vehicle through the displayed surrounding environment, and can conveniently park or drive the vehicle without seeing a side mirror or rear view mirror.

The related art of the present invention is disclosed in Korean Patent No. 1603609 published on Mar. 28, 2016 and entitled “Around View Monitoring System for Vehicle and Method Thereof.”

Since the surround view monitoring system generates a surround view based on limited images acquired by a plurality of cameras mounted on an ego vehicle, the surround view monitoring system has a limitation in expanding the area of the surround view to an image area of a neighboring vehicle to generate a wide area surround view. Furthermore, since the surround view monitoring system synthesizes image frames at different times, the surround view monitoring system may not reflect an image change with time.

The above information disclosed in this Background section is only for enhancement of understanding of the background of the invention and, therefore, it may contain information that does not constitute prior art.

### SUMMARY

Exemplary embodiments of the present invention provide a wide area surround view monitoring apparatus for a vehicle, which receives a camera image from a neighboring vehicle, generates a wide area surround view by synthesizing the camera image of the neighboring vehicle with a surround image of an ego vehicle, provides a collision prevention function through a degree of overlap between the images, and generates a local wide area image map around the ego vehicle, and a control method thereof.

In one embodiment, a wide area surround view monitoring apparatus for a vehicle may include: a camera module installed in an ego vehicle, and configured to acquire a surround image, wirelessly transmit the acquired surround image, wirelessly receive a camera image from a neighboring vehicle to measure RSSI (Received Signal Strength Indication), and transmit the RSSI with the surround image of the ego vehicle and the camera image of the neighboring vehicle through a vehicle network; and a control unit configured to receive the surround image of the ego vehicle, the camera image of the neighboring vehicle and the RSSI from the camera module through the vehicle network, determine and output a possibility of collision with the neighboring vehicle, configure a wide area Support Vector Machines (SVM) view by synthesizing the surround image of the ego vehicle with the camera image of the neighboring vehicle, and generate a local wide area image map by calculating a possible driving space of the ego vehicle.

The control unit may determine the possibility of collision with the neighboring vehicle based on the RSSI and a degree of overlap between the surround image of the ego vehicle and the camera image of the neighboring vehicle, and output the determination result to an autonomous driving unit.

The control unit may widen a target view direction of the camera module for a direction in which the camera image of the neighboring vehicle is not received, and acquires the surround image of the ego vehicle to configure the wide area SVM view.

The camera module may be a variable FOV (Field Of View) camera module to which a multilayer lens structure including a plurality of lenses is applied and whose FOV is varied as a focal length and refractive indexes of the respective lenses are controlled.

The control unit may transmit control information for widening the FOV to the camera module, for a direction in which the camera image of the neighboring vehicle is not received, and then acquire the surround image of the ego vehicle to configure the wide area SVM view.

The control unit may calculate a possible driving space based on an approach distance to the neighboring vehicle, a recognition state of an approaching object, and the maximum area of an image inputted from the camera module, and generate the local wide area image map in connection with a navigation system.

In another embodiment, a control method of a wide area surround view monitoring apparatus for a vehicle may include: acquiring, by a camera module, a surround image of an ego vehicle; wirelessly receiving, by the camera module, a camera image from a neighboring vehicle; measuring, by the camera module, RSSI of the received camera image; transmitting, by the camera module, the RSSI with the surround image of the ego vehicle and the camera image of the neighboring vehicle through a vehicle network; receiving, by the control unit, the RSSI with the surround image of the ego vehicle and the camera image of the neighboring vehicle from the camera module, and determining a possibility of collision with the neighboring vehicle; configuring, by the control unit, a wide area SVM view by synthesizing the surround image of the ego vehicle with the camera image of the neighboring vehicle; and generating, by the control unit, a local wide area image map by calculating a possible driving space of the ego vehicle.

The determining of the possibility of collision with the neighboring vehicle may include: determining, by the control unit, a degree of overlap between the surround image of the ego vehicle and the camera image of the neighboring vehicle; determining, by the control unit, an inter-vehicle distance to the neighboring vehicle based on the RSSI; and determining, by the control unit, the possibility of collision with the neighboring vehicle based on the degree of overlap and the inter-vehicle distance.

The control method may further include outputting, by the control unit, the possibility of collision with the neighboring vehicle to an autonomous driving unit.

The configuring of the wide area SVM view may include: determining, by the control unit, whether there is a direction in which the camera image of the neighboring vehicle is not received; expanding, by the control unit, the surround image of the ego vehicle in the direction where the camera image of the neighboring vehicle is not received, when there is the direction in which the camera image of the neighboring vehicle is not received; and configuring, by the control unit, the wide area SVM view by synthesizing the surround image of the ego vehicle with the camera image of the neighboring vehicle.

In the expanding of the surround image of the ego vehicle, the control unit may widen a target view direction of the camera module for the direction in which the camera image of the neighboring vehicle is not received, and acquire the surround image of the ego vehicle.

In the expanding of the surround image of the ego vehicle, the control unit may transmit control information for widening the FOV to the camera module, for the direction in which the camera image of the neighboring vehicle is not received, and then acquire the surround image of the ego vehicle.

The generating of the local wide area image map may include: calculating, by the control unit, an approach distance to the neighboring vehicle; recognizing, by the control unit, an approaching object; calculating, by the control unit, a possible driving space based on the approach distance to the neighboring vehicle, a recognition state of the approaching object and the maximum area of an image inputted from the camera module; and generating, by the control unit, the local wide area image map in connection with a navigation system depending on the possible driving space.

The generating of the local wide area image map may further include performing, by the control unit, sensing frequency control and camera FOV control for expanding an image of the camera module depending on the possible driving space.

In accordance with the embodiments of the present invention, the wide area surround view monitoring apparatus for a vehicle and the control method thereof may generate a wide area surround view by receiving camera images from neighboring vehicles and synthesizing surround images of the ego vehicle with the camera images, provide a collision prevention function through a degree of overlap between the images, and generate the local wide area image map around the ego vehicle. Therefore, the wide area surround view monitoring apparatus and the control method can increase the driver's driving convenience by widening the around view when the vehicle travels on an expressway, travels on a downtown street at low speed or is in a parking mode, support autonomous driving based on the local wide area image map without adding a high-resolution HD map and a high-performance GPS or IMU, and prevent a collision with a neighboring vehicle.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a wide area surround view monitoring apparatus for a vehicle in accordance with an embodiment of the present invention.

FIG. 2 is a diagram illustrating an arrangement of camera modules in the wide area surround view monitoring apparatus for a vehicle in accordance with the embodiment of the present invention.

FIGS. 3A and 3B are diagrams illustrating that images overlap each other in the wide area surround view monitoring apparatus for a vehicle in accordance with the embodiment of the present invention.

FIGS. 4A, 4B, and 4C are diagrams illustrating an example in which the wide area surround view monitoring apparatus for a vehicle in accordance with the embodiment of the present invention configures a wide area surround view monitoring (SVM) view.

FIGS. 5A, 5B, 5C, and 5D are diagrams illustrating an example in which the wide area surround view monitoring apparatus for a vehicle in accordance with the embodiment of the present invention expands an image to configure a wide area SVM view.

FIGS. 6A and 6B are diagrams illustrating an example in which the wide area surround view monitoring apparatus for a vehicle in accordance with the embodiment of the present invention configures a local wide area image map.

FIGS. 7A, 7B, 7C, and 7D are diagrams illustrating an example in which the wide area surround view monitoring apparatus for a vehicle in accordance with the embodiment of the present invention expands an image for generating the local wide area image map.

FIG. 8 is a flowchart for describing a control method of the wide area surround view monitoring apparatus for a vehicle in accordance with an embodiment of the present invention.

FIG. 9 is a flowchart for describing a process of configuring a local wide area image map in the control method of the wide area surround view monitoring apparatus for a vehicle in accordance with the embodiment of the present invention.

### DETAILED DESCRIPTION OF THE ILLUSTRATED EMBODIMENT

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated to into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereafter, a wide area surround view monitoring apparatus for a vehicle and a control method thereof in accordance with an embodiment of the present invention will be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

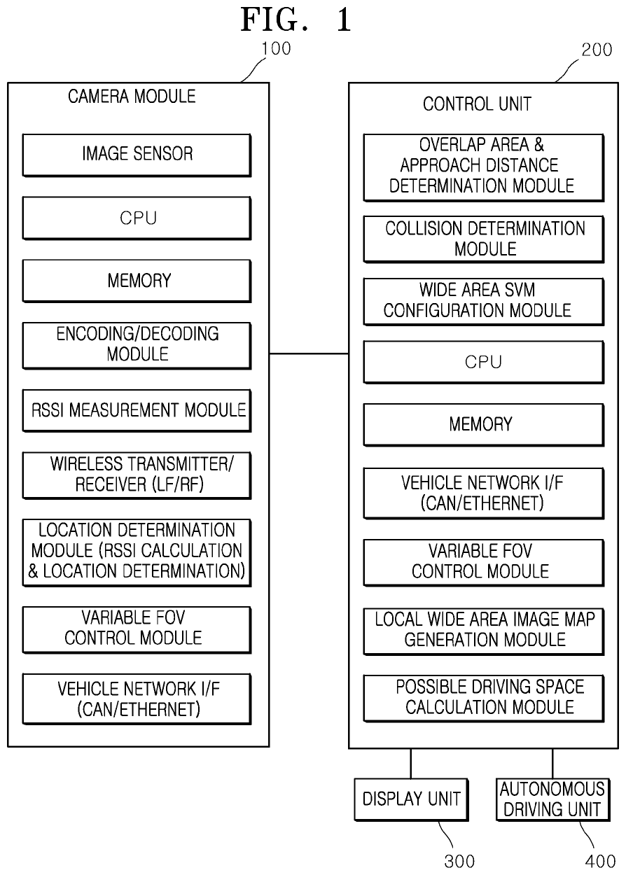

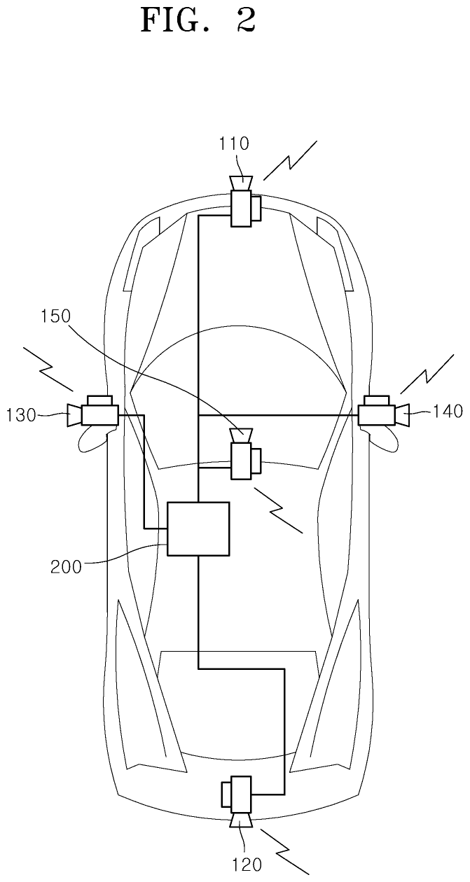

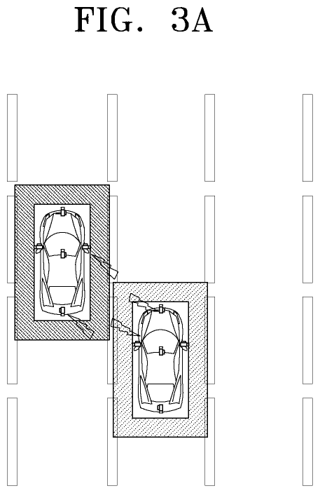

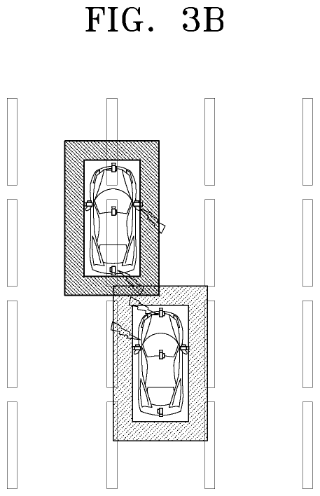

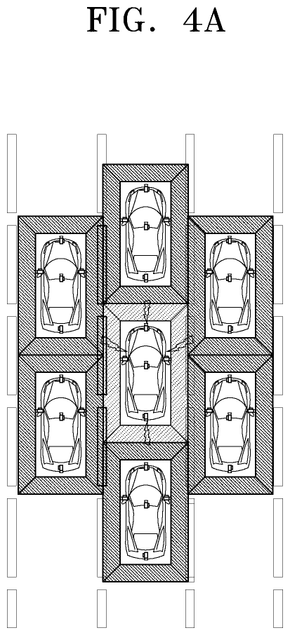

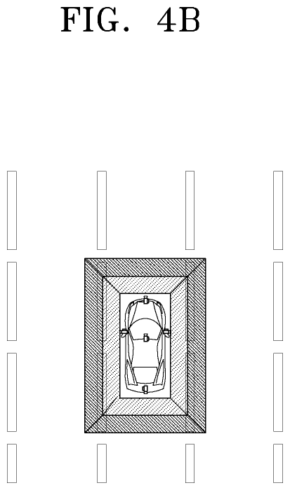

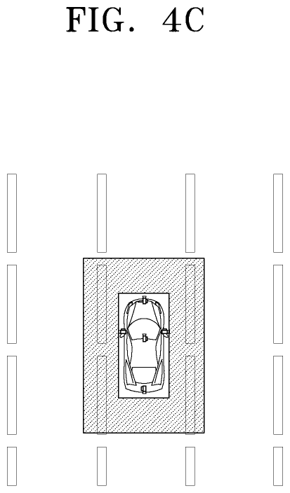

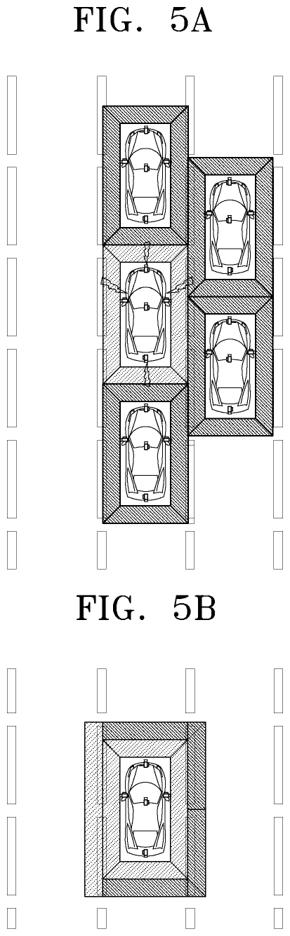

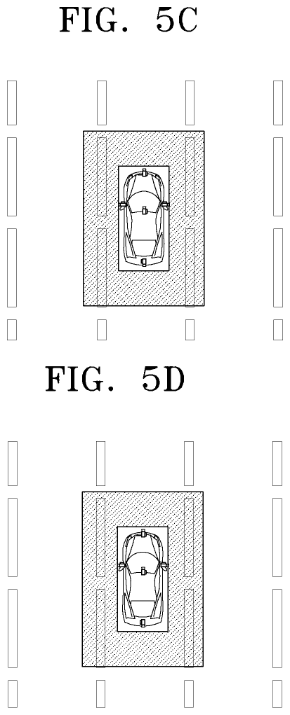

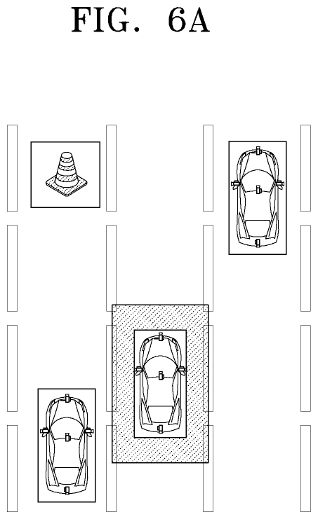

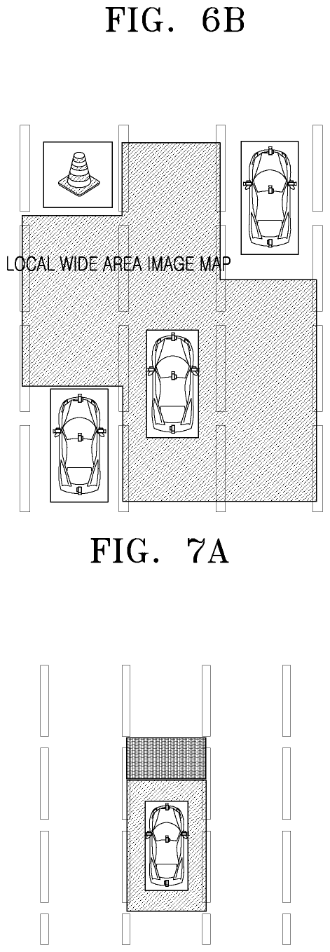

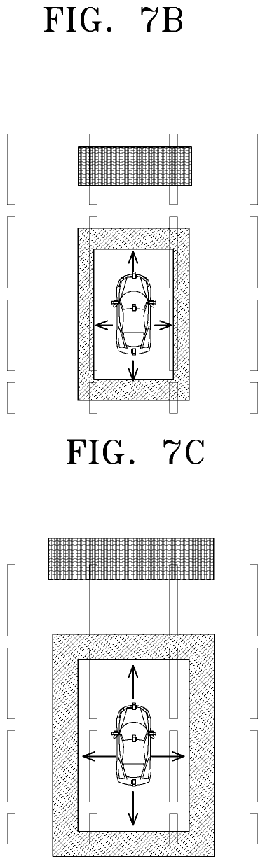

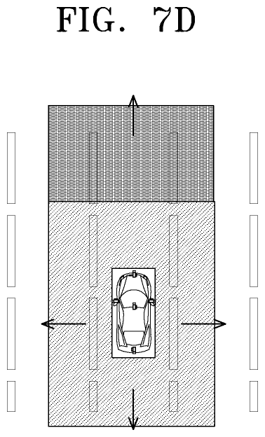

FIG. 1 is a block diagram illustrating a wide area surround view monitoring apparatus for a vehicle in accordance with an embodiment of the present invention, FIG. 2 is a diagram illustrating an arrangement of camera modules in the wide area surround view monitoring apparatus for a vehicle in accordance with the embodiment of the present invention, FIGS. 3A and 3B are diagrams illustrating that images overlap each other in the wide area surround view monitoring apparatus for a vehicle in accordance with the embodiment of the present invention, FIGS. 4A to 4C are diagrams illustrating an example in which the wide area surround view monitoring apparatus for a vehicle in accordance with the embodiment of the present invention configures a wide area surround view monitoring (SVM) view, FIGS. 5A to 5D are diagrams illustrating an example in which the wide area surround view monitoring apparatus for a vehicle in accordance with the embodiment of the present invention expands an image to configure a wide area SVM view, FIGS. 6A and 6B are diagrams illustrating an example in which the wide area surround view monitoring apparatus for a vehicle in accordance with the embodiment of the present invention configures a local wide area image map, and FIGS. 7A to 7D are diagrams illustrating an example in which the wide area surround view monitoring apparatus for a vehicle in accordance with the embodiment of the present invention expands an image for generating the local wide area image map.

As illustrated in FIGS. 1 and 2, the wide area surround view monitoring apparatus for a vehicle in accordance with the embodiment of the present invention may include a camera module 100 and a control unit 200.

As illustrated in FIG. 2, the camera module 100 may be installed at the front, rear, left, right and center of an ego vehicle, acquire surround images, wirelessly transmit the acquired surround images, wirelessly receive camera images from neighboring vehicles, calculate RSSI (Received Signal Strength Indication), and transmit the RSSI with the surround images of the ego vehicle and the camera images of the neighboring vehicle through a vehicle network.

In the present embodiment, the camera module 100 may be a variable FOV (Field Of View) camera module to which a multilayer lens structure including a plurality of lenses is applied, and of which the FOV is varied as a focal length and the refractive indexes of the respective lenses are controlled.

The variable FOV camera module may control the refractive indexes of the respective lenses by changing the properties of crystalline materials composing the respective lenses according to an electrical signal applied thereto. Furthermore, as the focal length is decreased, the FOV may be increased and the resolution may be decreased, and as the focal length is increased, the FOV may be decreased and the resolution may be increased. Thus, the variable FOV camera module may have various FOVs through combinations of the focal length and the refractive indexes of the respective lenses. That is, the FOV of the variable FOV camera module may be varied.

The configuration of the camera module 100 may be described in more detail as follows. The camera module 100 may include a CPU for controlling the operation of the camera module 100 and a memory for temporarily storing a surround image acquired through an image sensor or storing not only control information of the camera module 100 but also a program for the operation of the camera module 100.

As such, the camera module 100 may acquire a surround image by sensing the surrounding environment through an image sensor, receive a camera image of a neighboring vehicle by communicating with a camera of the neighboring vehicle through a wireless transmitter/receiver, maintain security through an encoding/decoding module when wirelessly transmitting/receiving camera images to/from the neighboring vehicle, measure the RSSI of an image signal received from the neighboring vehicle through an RSSI measurement module, and then determine an inter-vehicle distance from the neighboring vehicle based on the measured RSSI through a location determination module.

Furthermore, the camera module 100 may include a variable FOV control module for acquiring an expanded image by adjusting the FOV of the camera module 100 and controlling a sensing frequency of the image sensor.

The camera module 100 may transmit the RSSI with the surround image of the ego vehicle and the camera image of the neighboring vehicle to the control unit 200 through a vehicle network interface (I/F) with the control unit 200 based on CAN or Ethernet.

The control unit 200 may receive the surround image of the ego vehicle, the camera image of the neighboring vehicle and the RSSI from the camera module 100 through the vehicle network I/F, store the received information in a memory, determine a possibility of collision with the neighboring vehicle through an overlap area and approach distance determination module and a collision determination module, output the determined possibility, configure a wide area SVM view by synthesizing the surround image of the ego vehicle and the camera image of the neighboring vehicle through a wide area SVM configuration module, generate a local wide area image map by calculating a possible driving space of the ego vehicle through a possible driving space calculation module and a local wide area image map generation module, and output the generated local wide area image map to a display unit 300 and an autonomous driving unit 400.

More specifically, the control unit 200 may receive surround images of the ego vehicle from a front camera module 110, a rear camera module 120, a left camera module 130, a right camera module 140 and a center camera module 150, respectively, which are installed at the front, rear, left, right and center of the ego vehicle as illustrated in FIG. 2.

Each of the camera modules 100 may acquire a surround image according to FOV control and sensing frequency control which are performed by the control unit 200 through the variable FOV control module.

The control unit 200 may determine the possibility of collision with the neighboring vehicle based on the RSSI and a degree of overlap between the surround image of the ego vehicle and the camera image of the neighboring vehicle, as illustrated in FIG. 3.

That is, when the surround image of the ego vehicle and the camera image of the neighboring vehicle do not overlap each other as illustrated in FIG. 3A, there is no possibility of collision. Furthermore, even when the RSSI is low, the possible of collision may be low.

In a case illustrated in FIG. 3B, however, the surround image of the ego vehicle and the camera image of the neighboring vehicle may partially overlap each other. In this case, the control unit 200 may determine that the ego vehicle is close to the neighboring vehicle, and determine that the possibility of collision is high, even through the RSSI.

The control unit 200 may output the determination result of the possibility of collision to the autonomous driving unit 400, and control the autonomous driving unit 400 to perform steering and braking control and to issue a collision warning, depending on the possibility of collision with the neighboring vehicle.

The control unit 200 may configure a wide area SVM view by synthesizing the surround image of the ego vehicle with camera images of neighboring vehicles through the wide area SVM configuration module, as illustrated in FIGS. 4A to 4C.

That is, when neighboring vehicles are present around the ego vehicle as illustrated in FIG. 4A such that camera images of the neighboring vehicles are received in all directions, the camera images of the neighboring vehicles may be arranged at the edge of the surround image of the ego vehicle as illustrated in FIG. 4B. Therefore, when the control unit 200 synthesizes the surround image of the ego vehicle with the camera images of the neighboring vehicles, a wide area SVM view may be configured as illustrated in FIG. 4C, thereby expanding the visible area of the ego vehicle.

On the other hand, when a direction in which a camera image of a neighboring vehicle is not received is present as illustrated in FIGS. 5A to 5D, the control unit 200 may expand the target view direction of the camera module 100, and acquire a surround image of the ego vehicle to configure a wide area SVM view.

Alternatively, the control unit 200 may transmit control information for widening to the FOV to the camera module 100 through the variable FOV control module, and then acquire a surround image of the ego vehicle to configure a wide area SVM view.

That is, when no neighboring vehicle is present on the left of the ego vehicle as illustrated in FIG. 5A, a camera image of a neighboring vehicle may not be disposed on the left of the edge of the surround image of the ego vehicle as illustrated in FIG. 5C. Therefore, the control unit 200 may expand the surround image of the ego vehicle as illustrated in FIG. 5B, and configure a wide area SVM view illustrated in FIG. 5D by synthesizing the surround image of the ego vehicle with the camera images of the neighboring vehicles, thereby expanding the visible area of the ego vehicle.

The control unit 200 may calculate a possible driving space based on approach distances from the neighboring vehicles, a recognition state of an approaching object and the maximum area of an image inputted from the camera module, and generate a local wide area image map in connection with a navigation system.

As illustrated in FIG. 6A, the control unit 200 may expand and acquire a surround image of the ego vehicle by periodically changing the FOV of the camera module 100 at a high camera sensing frequency, and recognize an approach distance from a neighboring vehicle and an approaching object.

As the control unit 200 calculates a possible driving space in a wide area around the ego vehicle and configures a local wide area image map in connection with the navigation system as illustrated in FIG. 6B, the autonomous driving unit 400 can perform global and local path planning for autonomous driving through only the minimum GPS information provided by the navigation system without help of a high-resolution HD map and a high-performance GPS/IMU sensor.

When changing the sensing frequency of the camera module 100, the control unit 200 may compensate for a low-quality image area or an image area which is not secured due to the movement of the vehicle, with an image of the camera module 100 in the next sensing period, thereby securing the entire wide area image data. The local wide area image map secured in this manner may be stored in a storage space within the vehicle, or outputted to the display unit 300 and the autonomous driving unit 400.

When configuring the local wide area image map by increasing the camera sensing frequency and changing the FOV, the control unit 200 may actively change and control the sensing frequency and FOV of the camera module 100 in consideration of vehicle speed and time information, such that the wide area image data can sufficiently cover the vehicle moving distance to configure a continuous and natural local wide area image map without an image area which is not secured.

The control unit 200 may merge/synthesize the images as illustrated in FIG. 7D by varying the FOV of the camera module 100 in first to third stages as illustrated in FIGS. 7A to 7C, thereby securing the wide area image data.

In accordance with the embodiment of the present invention, the wide area surround view monitoring apparatus for a vehicle may generate a wide area surround view by receiving camera images from neighboring vehicles and synthesizing surround images of the ego vehicle with the camera images, provide a collision prevention function through a degree of overlap between the images, and generate the local wide area image map around the ego vehicle. Therefore, the wide area surround view monitoring apparatus can increase the driver's driving convenience by widening the around view when the vehicle travels on an expressway, travels on a downtown street at low speed or is in a parking mode, support autonomous driving based on the local wide area image map without adding a high-resolution HD map and a high-performance GPS or IMU, and prevent a collision with a neighboring vehicle.

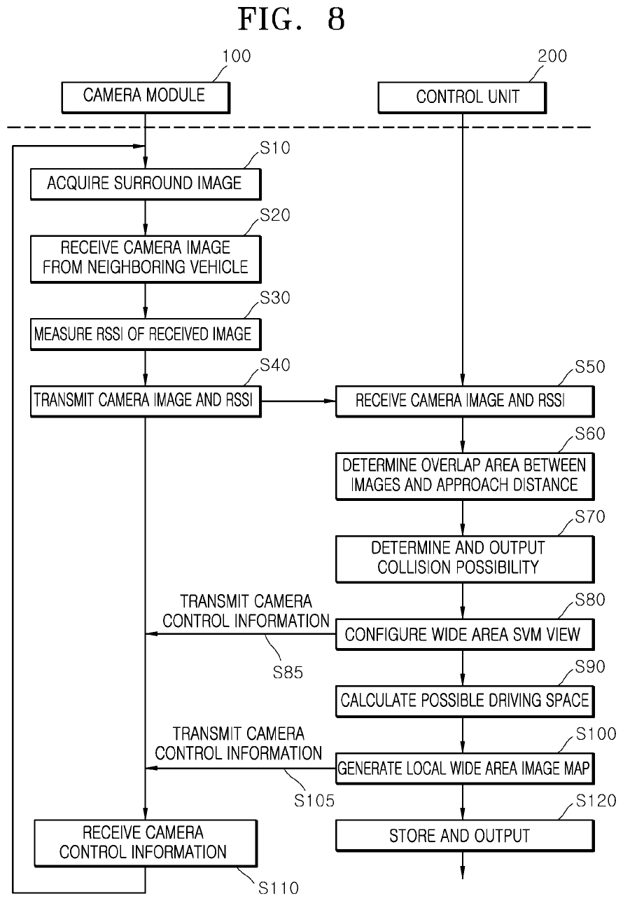

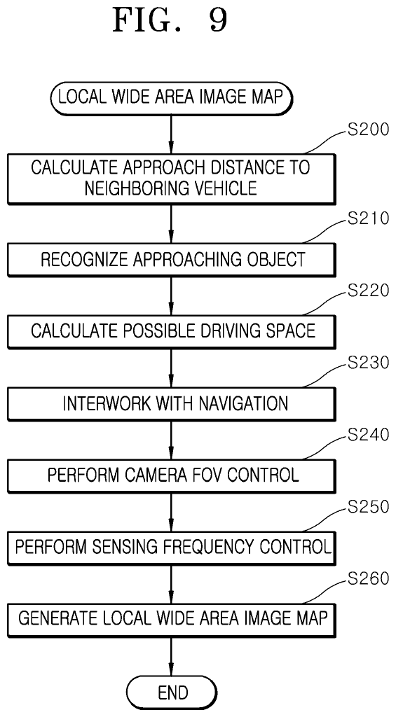

FIG. 8 is a flowchart for describing a control method of the wide area surround view monitoring apparatus for a vehicle in accordance with an embodiment of the present invention, and FIG. 9 is a flowchart for describing a process of configuring a local wide area image map in the control method of the wide area surround view monitoring apparatus for a vehicle in accordance with the embodiment of the present invention.

As illustrated in FIG. 8, the control method of the wide area surround view monitoring apparatus for a vehicle in accordance with the embodiment of the present invention may begin with step S10 in which the camera module 100 acquires a surround image of an ego vehicle.

After acquiring the surround image of the ego vehicle in step S10, the camera module 100 may wirelessly receive a camera image from a neighboring vehicle in step S20.

After wirelessly receiving the camera image from the neighboring vehicle in step S20, the camera module 100 may wirelessly measure RSSI of the camera image in step S30.

After measuring the RSSI of the camera image in step S30, the camera module 100 may transmit the RSSI with the surround image of the ego vehicle and the camera image of the neighboring vehicle to the control unit 200 through the vehicle network in step S40.

The surround image of the ego vehicle, the camera image of the neighboring vehicle and the RSSI, which are transmitted through the vehicle network in step S40, may be received by the control unit 200 in step S50.

After receiving the surround image of the ego vehicle and the camera image of the neighboring vehicle, which are transmitted from the camera module 100 in step S50, the control unit 200 may determine an overlap area between the surround image of the ego vehicle and the camera image of the neighboring vehicle, and determine an approach distance to the neighboring vehicle based on the RSSI, in step S60.

After determining the overlap area and the approach distance in step S60, the control unit 200 may determine a possibility of collision with the neighboring vehicle based on the overlap area and the approach distance, and output the possibility of collision to the autonomous driving unit 400 in step S70.

The control unit 200 may determine the possibility of collision with the neighboring vehicle based on the RSSI and the degree of overlap between the surround image of the ego vehicle and the camera image of the neighboring vehicle as illustrated in FIG. 3.

That is, when the surround image of the ego vehicle and the camera image of the neighboring vehicle do not overlap each other as illustrated in FIG. 3A, there is no possibility of collision. Furthermore, even when the RSSI is low, the possible of collision may be low.

In a case illustrated in FIG. 3B, however, the surround image of the ego vehicle and the camera image of the neighboring vehicle may partially overlap each other. In this case, the control unit 200 may determine that the ego vehicle is close to the neighboring vehicle, and also determine that the possibility of collision is high, through the RSSI.

As such, the control unit 200 may output the determination result of the possibility of collision to the autonomous driving unit 400, and thus control the autonomous driving unit 400 to perform steering and braking control and to issue a collision warning, depending on the possibility of collision with the neighboring vehicle.

After determining the possibility of collision with the neighboring vehicle in step S70, the control unit 200 may configure a wide area SVM view by synthesizing the surround image of the ego vehicle with the camera image of the neighboring vehicle in step S80.

When neighboring vehicles are present around the ego vehicle as illustrated in FIG. 4A such that camera images of the neighboring vehicles are received in all directions, the camera images of the neighboring vehicles may be arranged at the edge of the surround image of the ego vehicle as illustrated in FIG. 4B. Therefore, the control unit 200 may configure a wide area SVM view illustrated in FIG. 4C by synthesizing the surround image of the ego vehicle with the camera images of the neighboring vehicles, thereby expanding the visible area of the ego vehicle.

On the other hand, when there is a direction in which a camera image of a neighboring vehicle is not received as illustrated in FIGS. 5A to 5D, the control unit 200 may expand the target view direction of the camera module 100 to acquire the surround image of the ego vehicle, and configure a wide area SVM view.

Alternatively, the control unit 200 may transmit camera control information for widening the FOV to the camera module 100 in step S85.

When the control unit 200 transmits the camera control information for varying the FOV of the camera module 100 in step S85, the camera module 100 may receive the camera control information in step S110, and repeat the process of acquiring a surround image.

As such, the control unit 200 may configure the wide area SVM view by synthesizing the surround image of the ego vehicle, which is acquired after the control information for widening the FOV is transmitted to the camera module 100 in step S85, with the camera image of the neighboring vehicle.

That is, even when no neighboring vehicle is present on the left of the ego vehicle as illustrated in FIG. 5A, a camera image of a neighboring vehicle may not be disposed on the left of the edge of the surround image of the ego vehicle as illustrated in FIG. 5C. Therefore, the control unit 200 may configure the wide area SVM view as illustrated in FIG. 5D by expanding the surround image of the ego vehicle as illustrated in FIG. 5B and synthesizing the expanded surround image of the ego vehicle with the camera image of the neighboring vehicle, thereby expanding the visible area of the ego vehicle.

After configuring the wide area SVM view in step S80, the control unit 200 may calculate a possible driving space of the ego vehicle in step S90.

After calculating the possible driving space of the ego vehicle in step S90, the control unit 200 may transmit camera control information for FOV control and sensing frequency control to the camera module 100 in step S105. Then, the control unit 200 may generate a local wide area image map based on the surround image of the ego vehicle, received from the camera module 100, in step S100.

The process of generating the local wide area image map will be described in more detail with reference to FIG. 9. The control unit 200 may calculate an approach distance to the neighboring vehicle based on the surround image of the ego vehicle, the camera image of the neighboring vehicle and the RSSI, in step S200.

Based on the approach distance calculated in step S200, the control unit 200 may recognize an approaching object in step S210.

Based on the approach distance to the neighboring vehicle, calculated in step S200, the state of the approaching object recognized in step S210, and the maximum area of an image which can be inputted from the camera module 100 by varying the FOV, the control unit 200 may calculate the possible driving space of the ego vehicle in step S220.

The control unit 200 may receive GPS information in connection with the navigation system in step S230.

After calculating the possible driving space of the ego vehicle in step S220, the control unit 200 may vary the FOV through camera FOV control for expanding the image of the camera module depending on the possible driving space, in step S240, and perform sensing frequency control in step S250.

Then, the control unit 200 may generate a local wide area image map based on the surround image of the ego vehicle, received from the camera module 100, in step S260.

As illustrated in FIG. 6A, the control unit 200 may expand and acquire a surround image of the ego vehicle by periodically changing the FOV of the camera module 100 at a high camera sensing frequency, and recognize an approach distance to the neighboring vehicle and an approaching object.

As the control unit 200 configures the local wide area image map in connection with the navigation system by calculating the possible driving space for the wide area around the ego vehicle as illustrated in FIG. 6B, the autonomous driving unit 400 can perform global and local path planning for autonomous driving through only the minimum GPS information provided by the navigation system without help of a high-resolution HD map and a high-performance GPS/IMU sensor.

When changing the sensing frequency of the camera module 100, the control unit 200 may compensate for a low-quality image area or an image area which is not secured due to the movement of the vehicle, with an image of the camera module 100 in the next sensing period, and thus secure the entire wide area image data.

When configuring the local wide area image map by increasing the camera sensing frequency and changing the FOV, the control unit 200 may actively change and control the sensing frequency and FOV of the camera module 100 in consideration of vehicle speed and time information, such that the wide area image data can sufficiently cover the vehicle moving distance to configure a continuous and natural local wide area image map without an image area which is not secured.

The local wide area image map generated in step S100 may be stored in a storage space within the vehicle, or outputted to the display unit 300 and the autonomous driving unit 400 in step S120.

In accordance with the embodiment of the present invention, the control method of the wide area surround view monitoring apparatus for a vehicle may generate a wide area surround view by receiving camera images from neighboring vehicles and synthesizing surround images of the ego vehicle with the camera images, provide a collision prevention function through a degree of overlap between the images, and generate the local wide area image map around the ego vehicle. Therefore, the control method can increase the driver's driving convenience by widening the around view when the vehicle travels on an expressway, travels on a downtown street at low speed or is in a parking mode, support autonomous driving based on the local wide area image map without adding a high-resolution HD map and a high-performance GPS or IMU, and prevent a collision with a neighboring vehicle.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A wide area surround view monitoring apparatus for an ego vehicle, comprising:
a camera module installed in the ego vehicle, and configured to acquire a surround image, wirelessly transmit the acquired surround image, wirelessly receive a camera image from a neighboring vehicle to measure Received Signal Strength Indication (RSSI), and transmit the RSSI with the surround image of the ego vehicle and the camera image of the neighboring vehicle through a vehicle network; and
a controller configured to receive the surround image of the ego vehicle, the camera image of the neighboring vehicle and the RSSI from the camera module through the vehicle network, determine and output a possibility of collision with the neighboring vehicle, configure a wide area Support Vector Machines (SVM) view by synthesizing the surround image of the ego vehicle with the camera image of the neighboring vehicle, and generate a local wide area image map by calculating a possible driving space of the ego vehicle.

2. The wide area surround view monitoring apparatus of claim 1, wherein the controller is configured to determine a possibility of collision with the neighboring vehicle based on the RSSI and a degree of overlap between the surround image of the ego vehicle and the camera image of the neighboring vehicle, and to output the determination result to an autonomous driving unit.

3. The wide area surround view monitoring apparatus of claim 1, wherein the controller is configured to widen a target view direction of the camera module for a direction in which the camera image of the neighboring vehicle is not received, and to acquire the surround image of the ego vehicle to configure the wide area SVM view.

4. The wide area surround view monitoring apparatus of claim 1, wherein the camera module is a variable Field of View (FOV) camera module to which a multilayer lens structure including a plurality of lenses is applied and whose FOV is varied as a focal length and refractive indexes of respective lenses of the plurality of lenses are controlled.

5. The wide area surround view monitoring apparatus of claim 4, wherein the controller is configured to transmit control information for widening the FOV to the camera module, for a direction in which the camera image of the neighboring vehicle is not received, and then to acquire the surround image of the ego vehicle to configure the wide area SVM view.

6. The wide area surround view monitoring apparatus of claim 1, wherein the controller is configured to calculate a possible driving space based on an approach distance to the neighboring vehicle, a recognition state of an approaching object, and a maximum area of an image inputted from the camera module, and to generate the local wide area image map in connection with a navigation system.

7. A control method of a wide area surround view monitoring apparatus for an ego vehicle, comprising the steps of:
acquiring, by a camera module, a surround image of the ego vehicle;
wirelessly receiving, by the camera module, a camera image from a neighboring vehicle;
measuring, by the camera module, a Received Signal Strength Indication (RSSI) of the received camera image;
transmitting, by the camera module, the RSSI with the surround image of the ego vehicle and the camera image of the neighboring vehicle through a vehicle network;
receiving, by a controller, the RSSI with the surround image of the ego vehicle and the camera image of the neighboring vehicle from the camera module, and determining a possibility of collision with the neighboring vehicle;
configuring, by the controller, a wide area Support Vector Machines (SVM) view by synthesizing the surround image of the ego vehicle with the camera image of the neighboring vehicle; and
generating, by the controller, a local wide area image map by calculating a possible driving space of the ego vehicle.

8. The control method of claim 7, wherein the step of determining of the possibility of collision with the neighboring vehicle comprises the steps of:
determining, by the controller, a degree of overlap between the surround image of the ego vehicle and the camera image of the neighboring vehicle;
determining, by the controller, an inter-vehicle distance to the neighboring vehicle based on the RSSI; and
determining, by the controller, the possibility of collision with the neighboring vehicle based on the degree of overlap and the inter-vehicle distance.

9. The control method of claim 8, further comprising outputting, by the controller, the possibility of collision with the neighboring vehicle to an autonomous driving unit.

10. The control method of claim 7, wherein the step of configuring of the wide area SVM view comprises the steps of:
determining, by the controller, whether there is a direction in which the camera image of the neighboring vehicle is not received;
expanding, by the controller, the surround image of the ego vehicle in the direction where the camera image of the neighboring vehicle is not received, when there is the direction in which the camera image of the neighboring vehicle is not received; and
configuring, by the controller, the wide area SVM view by synthesizing the surround image of the ego vehicle with the camera image of the neighboring vehicle.

11. The control method of claim 10, wherein in the step of expanding of the surround image of the ego vehicle, the controller is configured to widen a target view direction of the camera module for the direction in which the camera image of the neighboring vehicle is not received, and to acquire the surround image of the ego vehicle.

12. The control method of claim 10, wherein in the step of expanding of the surround image of the ego vehicle, the controller is configured to transmit control information for widening a Field of View (FOV) to the camera module, for the direction in which the camera image of the neighboring vehicle is not received, and then to acquire the surround image of the ego vehicle.

13. The control method of claim 7, wherein the step of generating of the local wide area image map comprises:
calculating, by the controller, an approach distance to the neighboring vehicle;
recognizing, by the controller, an approaching object;
calculating, by the controller, a possible driving space based on the approach distance to the neighboring vehicle, a recognition state of the approaching object and a maximum area of an image inputted from the camera module; and
generating, by the controller, the local wide area image map in connection with a navigation system depending on the possible driving space.

14. The control method of claim 13, wherein the step of generating of the local wide area image map further comprises the steps of performing, by the controller, sensing frequency control and camera Field of View (FOV) control for expanding an image of the camera module depending on the possible driving space.
